(19) United States
(12) Patent Application Publication
(10) Pub. No.: US 2010/0206242 A1
(43) Pub. Date: Aug. 19, 2010

(54) Massage therapy system for animals

(76) Inventor: Martha S. Jones, Maricopa, AZ (US)

Correspondence Address: TOD R NISSLE, PO BOX 55630, PHOENIX, AZ, 85078, US

(21) Appl. No.: 12/590,247

(22) Filed: Nov. 4, 2009

Related U.S. Application Data
(63) Continuation-in-part of application No. 11/906,203, filed on Sep. 28, 2007, now abandoned.
Application No. 11/906,203 is a continuation-in-part of application No. 11/145,465, filed on Jun. 2, 2005, now abandoned.

(51) Int. Cl. A01K 13/00

(52) U.S. Cl. 119/601

(57) ABSTRACT

A method to massage and groom a four-legged animal includes the steps of providing a paw shaped glove, of selecting a vibrator that produces vibrations that are like by the animal and have a selected frequency and magnitude and that produces a sound liked by the animal and having a selected magnitude and frequency, of mounting the vibrator on the glove, and of massaging and grooming the animal with the glove.

This is a continuation-in-part of U.S. patent application Ser. No. 11/906,203 filed Sep. 28, 2007 which is a continuation-in-part of U.S. patent application Ser. No. 11/145,465 filed Jun. 2, 2005.

This invention pertains to therapeutic apparatus and methods for an animal.

More particularly, the invention pertains to an apparatus and method that appeal simultaneously to multiple ones of an animal's sense of touch, sense of smell, sense of sight, sense of taste, and sense of hearing to sooth and relax the animal and to improve the animal's disposition.

In a further respect, the invention pertains to an apparatus that facilitates simultaneously soothing an animal, massaging the animal, and grooming the animal.

U.S. Pat. Nos. 5,768,709 and 5,577,273 describe a glove used to groom an animal. If desired, a vibrating unit can be mounted on the back of the glove to transmit vibrations through the user's hand and glove to an animal.

U.S. Pat. No. 5,009,195 describes a pliable sheet of material that is wrapped around a user's hand and is used to groom an animal.

The prior art devices described in the afore-mentioned patents are useful, but appear to have disadvantages in certain situations.

First, each of the prior art devices has bristles. When small cats and dogs, or even larger animals, are being groomed, bristles can be uncomfortable to tender skin areas of the animal.

Second, cleaning animal fur from bristles can be relatively time consuming, especially if the animal is shedding.

Third, the appearance of the prior art devices can be alarming to an animal. Many animals have been punished or abused by a human hand. Consequently, when an animal views a human being wearing the prior art devices, the animal may do so with alarm because the animal is uncertain of the action it is about to encounter. This can make it difficult for the animal to relax while being groomed.

Fourth, since the massage unit is mounted on the back of the prior art devices, it is difficult for a user to transmit vibration energy through the fingertips of the user's hand.

Fifth, the prior art devices appear to focus on appealing only to the sense of touch of an animal, and do not focus on appealing to other senses of an animal to facilitate the therapeutic treatment of the animal.

Accordingly, it would be highly desirable to provide an improved therapeutic apparatus and method for an animal that would groom and massage an animal with minimal discomfort, that would require minimal time to clean, and that would simultaneously appeal to multiple ones of the animal's senses to therapeutically treat the animal.

Therefore, it is a principal object of the invention to provide an improved therapeutic apparatus and method for an animal, including animals having a fur coat.

A further object of the invention is to provide an improved therapeutic apparatus and method that would groom an animal's fur and massage the animal while causing minimal discomfort.

Another object of the invention is to provide an improved therapeutic device that more effectively soothes and relaxes an animal and improves the animal's disposition.

These and other, further and more specific objects and advantages of the invention will be apparent from the following detailed description of the invention, taken in conjunction with the drawings, in which:

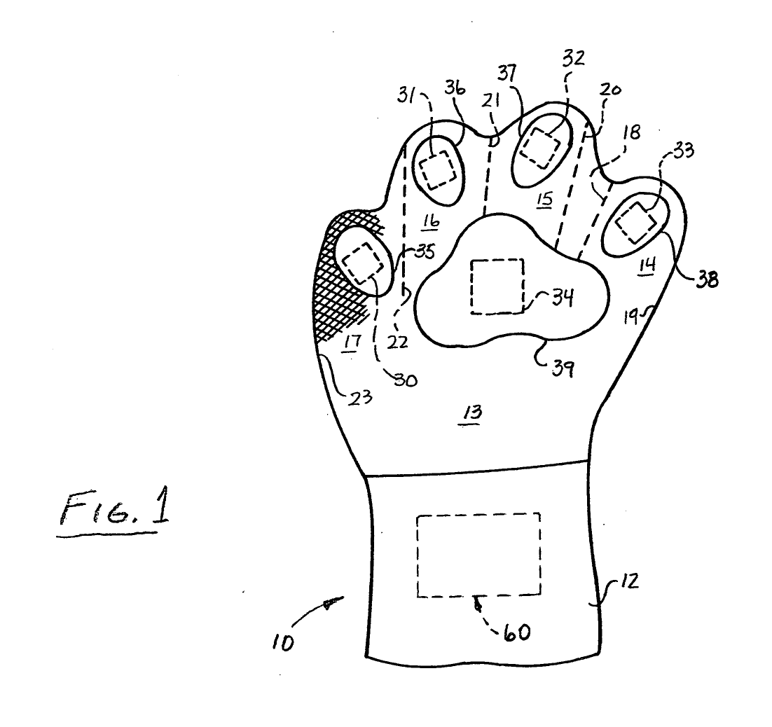

FIG. 1 is an exploded assembly view illustrating a therapeutic device constructed in accordance with the principles of the invention;

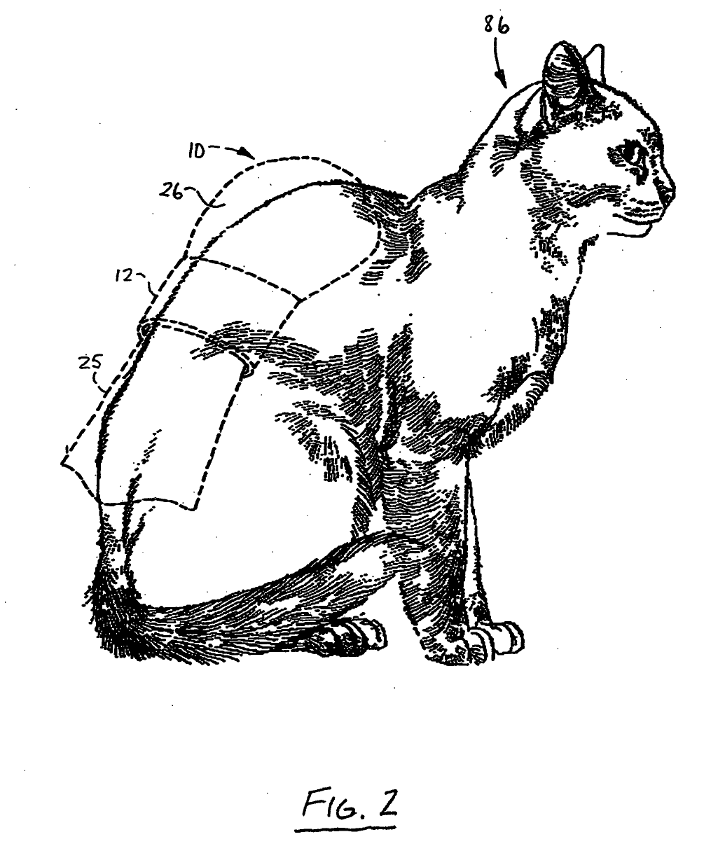

FIG. 2 is a perspective view illustrating mode of operation of the invention;

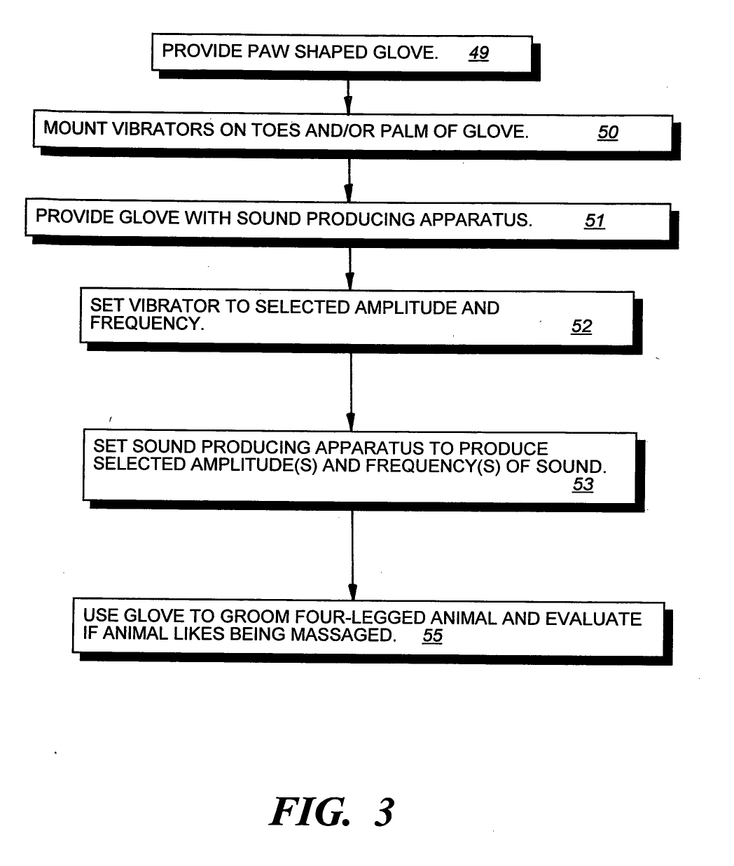

FIG. 3 is a flow chart diagram further illustrating the mode of operation of the invention; and,

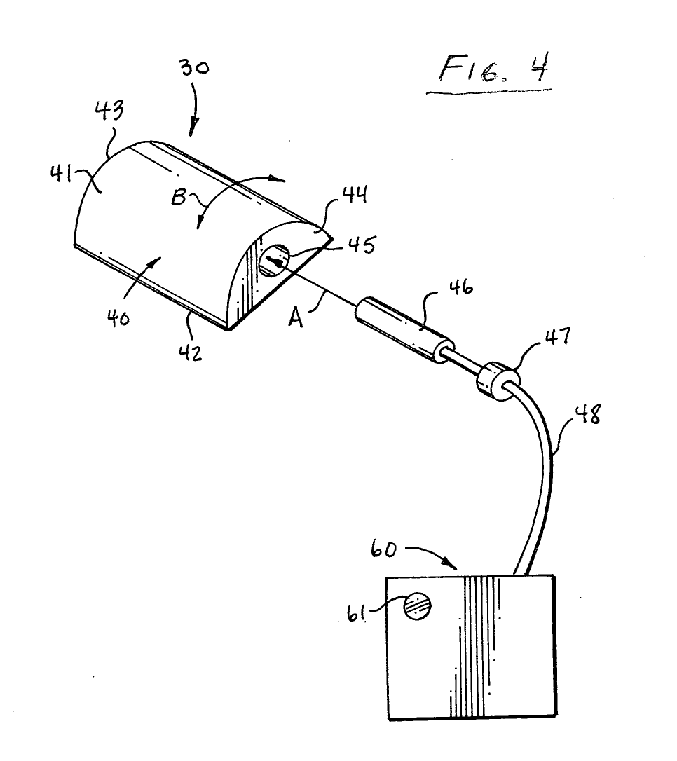

FIG. 4 is a perspective view illustrating one preferred construction of a vibrator utilized in the glove of the invention.

Briefly, in accordance with my invention, I provide an improved method to groom and massage a four-legged animal having a fur coat. The method comprises the steps of providing a paw-shaped glove having a palm and fingers; selecting a first sound having a selected frequency and amplitude; selecting a first vibrator which produces vibrations having a selected frequency and magnitude of vibration, and the first sound having a said selected frequency and amplitude; mounting the vibrator on one of a group consisting of the palm and the fingers of the glove; operating the vibrator to produce the vibrations and the sound; grooming the four-legged animal with the glove; and, determining ff the four-legged animal likes being groomed with the glove. If the four-legged animal does not like being groomed with the glove, a second vibrator is selected to replace the first vibrator. The second vibrator has at least one property different from the first vibrator, said property being selected from a group consisting of a sound different from the sound produced by the second vibrator, a frequency of vibration different from the frequency of vibration produced by the second vibrator, and the a magnitude of vibration different from the magnitude of vibration produced by the vibrator. The second vibrator is mounted on the glove in place of the first vibrator; and the four-legged animal is again groomed with the glove to determine if the animal likes being groomed with the glove. Alternatively, if the four-legged animal does not like being groomed with the glove, the first vibrator can be adjusted to change at least one property selected from a group consisting of a sound different from the first sound produced by the first vibrator, a frequency different from the frequency of vibration produced by the first vibrator, and a magnitude of vibration different from the magnitude of vibration produced by the first vibrator; after which the glove is again used on a four-legged animal to determine if the animal likes being groomed with the glove.

In another embodiment of the invention, I provide an improved method to groom and massage a four-legged animal having a fur coat. The method includes the steps of providing a paw-shaped glove having a palm and fingers; selecting a first sound having a selected frequency and amplitude liked by the four-legged animal; selecting a first vibrator which produces vibrations liked by the four-legged animal and having a selected frequency and magnitude of vibration; mounting the vibrator on one of a group consisting of the palm and the fingers of said glove; and, simultaneously producing the first sound. operating the vibrator to produce the vibrations, and, grooming the four-legged animal with the glove. The glove has an exterior and can includes microfibers on said exterior.

In a further embodiment of the invention, I provide an improved method to massage and groom a four-legged animal having a fur coat. The method comprises the steps of providing a pliable paw-shaped glove having a palm, pliable pads on the palm, finger stalls inside the glove, and imitation fur on the palm; selecting a first sound having a selected frequency(s) and amplitude(s); selecting a first vibrator which produces vibrations having a selected frequency and magnitude of vibration, and the first sound having the selected frequency and amplitude, and, includes an arcuate outer surface; mounting the vibrator on the palm of the glove beneath one of the pads such that the arcuate outer surface faces the pad; operating the vibrator to produce the vibrations and said sound; massaging and grooming the four-legged animal with the glove while rolling the one of the pads and the arcuate surface of the vibrator over the animal. The vibrator can include a wood housing; an opening extending into the housing; and, a vibrator motor mounted in the opening in the housing; and, can produce sound having an amplitude of less than sixty decibels. The method can also include determining if the four-legged animal likes being groomed with the glove; and, if the four-legged animal does not like being massaged and groomed with the glove, the additional steps of selecting a second vibrator to replace the first vibrator, the second vibrator having at least one property different from the first vibrator, the property being selected from a group consisting of a sound different from the first sound produced by the first vibrator, a frequency of vibration different from the frequency of vibration produced by the first vibrator, and a magnitude of vibration different from the magnitude of vibration produced by the first vibrator; mounting the second vibrator on the glove instead of said first vibrator; and operating the vibrator to produce the vibrations and said sound; massaging and grooming the four-legged animal with the glove while rolling the one of the pads and the arcuate surface of the vibrator over the animal. The method can also include determining if the four-legged animal likes being groomed with the glove; and, if the four-legged animal does not like being massaged and groomed with the glove, the additional steps of adjusting the first vibrator to change at least one property selected from a group consisting of a sound different from the first sound produced by the first vibrator, a frequency of vibration different from the frequency of vibration produced by the first vibrator, and a magnitude of vibration different from the magnitude of vibration produced by the first vibrator; and, operating the vibrator to produce the vibrations and said sound; massaging and grooming the four-legged animal with the glove while rolling the one of the pads and the arcuate surface of the vibrator over the animal.

Turning now to the drawings, which depict the presently preferred embodiments of the invention for the purpose of illustrating the practice thereof and not by way of limitation of the scope of the invention, and in which like reference characters refer to corresponding elements throughout the several views, FIG. 1 is an exploded assembly view illustrated a therapeutic device constructed in accordance with the principles of the invention and including a paw-shaped glove apparatus that includes paw-shaped glove 10.

Glove 10 can be fabricated from any desired material, but presently preferably includes a soft outer fur-like exterior that feels comfortable to an animal being massaged and groomed with glove 10. The fur-like exterior can comprise at least in part natural fur from animals, but preferably comprises at least in part artificial fur or another soft fabric material. As used herein, the term fabric includes material made by weaving, felting, knitting, knitting, bonding, or crocheting natural or synthetic fibers and/or filament. Examples of natural fibers are, without limitation, cotton, wood, and silver. Examples of synthetic fibers are, without limitation, nylon, rayon and KEVLAR™. In one preferred embodiment of the invention, the fur-like material comprises artificial or imitation fur. The exterior material on glove 10 is comfortable to an animal if the animal likes being contacted by the exterior material and gently stroked with glove 10. Tests are discussed below for determining in accordance with the invention whether an animal likes being contacted by and stroked with glove 10. Animals normally like being contacted by and stroked with a fur or fur-like material.

Aggression by an animal comprises unprovoked and unjustified threatening or injurious behavior by an animal. These symptoms presume that the animal is physically healthy does not have a cold, flu, rabies, an injury, or some other physical illness that produces or causes the symptoms. If a first cat is being petted gently by its owner, is not being restrained or teased or otherwise abused, and without cause elects to bite and claw the owner, that constitutes aggression. If a second cat is walking by minding its own business, and the first cat elects without cause to attack the second cat, that is aggression. On the other hand, if a mother cat attacks a dog that get too close to her kittens, even if the dog obviously has no intention of harming the kittens, that is not aggression, that is the natural instinct of the mother cat to protect her young.

Depression by an animal occurs when the animal is lethargic and obviously does not partake in its normal activities. The animal won't eat, won't play with any enthusiasm, sits around, doesn't sleep well, and may “cry” in its sleep. These symptoms presume that the animal is physically healthy and does not have a cold, flu, injury or some other physical illness that produces or causes the symptoms. One event that can trigger depression of a cat, dog or other pet is having a member of the family leave: for example, when a youngster leaves for summer camp, college, to get married, etc.

Anxiety by an animal occurs when the animal is abnormally hyperactive. The animal is nervous, may itch, tends not to stay put, won't sleep or won't sleep well, and, may pee in the house. A good example of anxiety occurs when a pet is anxious when it hears the thunder and other sounds produced during a thunderstorm. A dog, for instance, may refuse to sleep or lie during the storm, and to constantly walk around panting. These symptoms again presume that the animal is physically healthy and does not have a cold, flu, injury or some other physical illness that produces or causes the symptoms.

A contented disposition is the absence of anxiety, depression, and aggression.

The shape of glove 10 is important. Many animals have, as noted, been punished or abused by a human hand and view the approach of a human hand with trepidation. Consequently, the glove 10 is preferably shaped like the paw of an animal, or has some shape other than the shape of a human hand in which the fingers of the hand are readily recognized. It definitely is not preferred to utilize a glove that has separate stalls each shaped and dimensioned to relatively closely conform to and fit a finger of a human hand.

FIG. 1 illustrates the front side of glove 10, including palm area 13 and toe areas 14, 15, 16, 17. Pad 39 is affixed to palm area 13. Pads 35 to 38 are affixed to toe areas 17 to 14, respectively. A vibrator unit 34 is mounted on the palm 13 beneath pad 39. Vibrator unit 30 is mounted on the toe 17 beneath pad 35. Vibrator unit 31 is mounted on toe 16 beneath pad 36. Vibrator 32 is mounted on toe 15 beneath pad 37. Vibrator 33 is mounted on toe 14 beneath pad 38. Pads 35 to 39 can comprise part of vibrators 30 to 34, respectively. Vibrators 30 to 34 can be operated simultaneously or individually or only a selected portion of vibrators 30 to 34 need be operated. Each vibrator has, in conventional fashion, a power source that can comprise a battery, can comprise an electrical cord leading to a wall socket or other supply of electricity, and so on. One switch can be provided to turn on all of the vibrators at once, or multiple switches can be provided to turn on vibrators one at a time or in selected groupings. When a user's left hand is inserted palm up in the glove 10 that is illustrated in FIG. 1, the thumb of the left hand extends under toe 17, the palm of the left hand is immediately under and contacts palm 13, and each vibrator 30 to 34 is positioned between the palm or at least one finger of the left hand and its associated pad 35 to 39. This is believed important in the glove of the invention because an individual can use his fingertips to directly, gently, and independently vary the pressure of the vibrators 30 to 33 against the body of animal while massaging and/or stroking the animal.

Glove 10 can, if desired, include internal ribs 18, 20, 21, 22 that define stalls for the fingers of a user's hand. If, for example, a user's left hand is inserted palm up into glove 10 in FIG. 1 in the manner earlier described, the little finger (4^{th} finger) and 3^{rd} finger of the hand are in the stall extending between rib 18 and the side 19 of glove 10; the middle finger (2^{nd} finger) is in the stall extending between ribs 20 and 21; the index finger (1^{st} finger) is in the stall extending between ribs 21 and 22; and, the thumb is in the stall extending between rib 22 and the side 23 of the glove. The ribs 18, 20 to 22 can be formed by stitching together along a line the front (FIG. 1) and back 26 (FIG. 2) of the glove 10; can be formed by inserting and securing inside glove 10 long thin panel members; or can be formed in any other desired manner. Defining stalls inside glove 10 is important in the practice of the invention because it facilitates independent movement of the fingers and facilitates maintaining the user's fingertips in position behind their associated vibrator 30 to 33 during use of the glove. Vibrator 34 ordinarily, but not necessarily, is larger than vibrators 30 to 33 and is important in increasing the area of an animal's body that is subjected to vibration when the animal is massaged and groomed.

In use, a user's hand is slipped into glove 10 in the manner illustrated in FIG. 2, the vibrators 30 to 34 are (if desired) turned on, and the front of the glove is gently pressed against the body of a cat 26 or other animal. The user gently kneads the cat's body by bending and moving his fingers and palm inside glove 10. When the glove 10 is moved or stroked over the fur on the body of the animal 26, the exterior surface of glove 10 may collect loose fur, as well as dirt and grease. Massaging animal 26 with glove 10 stimulates oil glands associated with the fur and gives the fur a desirable sheen.

The frequency of sound produced by the vibrator(s) 30 to 34 is important and depends on the particular kind of animal being groomed. A lower frequency range, typically in the range of 220 Hz to 2349.32 Hz, is preferred for a cat. This range is, by way of example and not limitation, represented on a piano by the note A3 (220.00 Hz, 557 cm wavelength) to D7 (2349.32 Hz, 14.7 cm wavelength). Shorter or longer frequencies outside this range are more likely to irritate a cat. A higher frequency, typically in the range of 65.41 Hz to 2093.00 Hz is preferred for a dog. This range is, by way of example and not limitation, represented on a piano by the notes C2 (65.41 Hz 527 cm wavelength) to C7 (2093.00 Hz, 16.5 cm wavelength). Shorter or longer frequencies outside this range are more likely to irritate a dog. Desirable frequencies for other domesticated animals and other animals can normally can be identified with minimal experimentation.

The embodiment of the method of the invention set forth in FIG. 3 includes the steps of provide paw shaped glove 49, mount vibrators on toes and/or palm of glove 50, provide glove with sound producing apparatus 51, set vibrator to selected amplitude and frequency 52, set sound producing apparatus to produce selected amplitude(s) and frequency(s) of sound 53, and, use glove to groom and massage four legged animal and evaluate if animal like being groomed with the glove 55. As noted, the vibrator can, if desired, serve as the sound producing apparatus. The sound producing apparatus can produce continuously the same frequency and amplitude of sound, i.e., produce sound that is comparable to a note or chord; or, the sound produced can comprise a variety of different notes and amplitudes as would be the case if the sound were a melody or were a song being sung (accompanied or unaccompanied by a band or other musician(s)).

In determining if an animal likes being groomed and massaged with a glove constructed in accordance with the invention, animals often communicate more effectively with mannerisms than human beings are able to communicate with words. Once a grooming and massaging glove of the invention is configured with a particular vibrator and sound producing apparatus, the testing procedure of the invention to determine if the animal likes the grooming and massaging glove is straightforward.

One simple test to determine in accordance with the invention whether an animal likes being groomed and massaged with the glove of the invention is whether the animal stays and continues to be groomed and massaged, or, whether the animal attempts to leave. If an animal does not like being groomed and massaged with the glove, the animal will attempt to get away from the glove.

A further simple test to determine in accordance with the invention whether an animal likes being groomed and massaged with the glove of the invention is whether the animal becomes, or remains, calm and submissive while being groomed and massaged with the glove. If the animal becomes agitated while being massaged and groomed with the glove, that suggests the animal does not like being massaged and groomed. If, on the other hand, the animal is calm and submissive, that indicates the animal likes being massaged and groomed.

Another simple test to determine in accordance with the invention whether an animal likes being massaged and groomed with the glove of the invention is whether the animal is, while being massaged and groomed with the glove, willing to lie down in a calm and submissive state while being massaged and groomed and to relax to the point at which the eyes of the animal begin to partially or completely close. Often times, the eyes of a cat or dog will, when the animal likes being massaged and groomed with the glove, close at least halfway when the grooming glove of the invention is utilized and the animal begins to relax.

Still a further simple test to determine in accordance with the invention whether an animal likes being massaged and groomed with the glove of the invention is whether the animal after being massaged and groomed a first time will, on seeing an individual holding the glove, voluntarily approach the individual and look at the glove asking to be massaged and groomed. Conversely, if the animal, after being massaged and groomed the first time, sees the glove in an individual's hand and runs and moves away from the individual, that indicates the animal does not like being massaged and groomed with the glove.

The following definitions A to I were known prior to 2005. Judicial notice is taken of the definitions and they are evidence to be utilized in evaluating the invention.
A. Homeostasis is a tendency toward maintenance of a relatively stable psychological condition of the individual with respect to contending drives, motivations, and other psychodynamic forces.
B. Emotion is (1) turmoil or agitation in feeling or sensibility (the nerveless dreamer, who spends his life in a weltering sea of sensibility and˜—William James><love between men and women—is such a hot, stupid, middling thing, all˜and no thought—rose Macaulay> (2) a physiological departure from homeostasis that is subjectively experienced in strong feeling (as of love, hate, desired, or fear) and manifests itself in neuromuscular, respiratory, cardiovascular, hormonal, and other bodily changes preparatory to overt acts which may or may not be performed—often used in plural (how can I describe my˜s at this catastrophe—Mary W. Shelley> (3) an instance of such turmoil or agitation in feeling or sensibility: state of strong feeling (as of gear, anger, disgust, grief, joy, or surprise) <he felt a sudden rage but quickly controlled the˜><overcome with the˜of grief when he heard of his friend's death><the girl hardly knew what love was since she had never before experienced so tender an˜>
C. Express is (1) to represent in words: STATE, UTTER, <˜an opinion><˜his views> (2) to give expression to (an emotion or feeling)<when I˜ed disgust he and other laughed—David Livingstone><her countenance ˜ed both shame and defiance>
D. Countenance is (1) a: calm expression: facial expression indicating composure <he kept his˜so well that he had the air of having made a finished speech ______ G. B. Shaw>; also: mental composure <startled and also somewhat out of˜—Arnold Bennett> (2) the expressive appearance of one's face: LOOK, EXPRESSION <a˜which expressed both good humor and intelligence ______ Sir Walter Scott>
E. Emote is to give expression to emotion <June is the month when more Americans˜than at any other time of year ______ E. A. Weeks><knowledge about how man˜s and about what structure in the brain and what physiological devices therein produce emotions—Jour. Amer. Med. Assoc.>
F. Like is to feel attraction toward or take pleasure in <which friend he˜s best>: FAVOR <˜s some vegetables and dislikes others>: ENJOY <˜s doing business with them>
G. Fur-like means to resemble fur. One example of fur-like material is artificial material that resembles the fur of a real mink and is used to make an artificial mink stole. By way of example and not limitation, other fur-like materials consist of artificial and imitation furs long produced by a variety of manufacturers.
H. Resemble means to be like or similar to or to bear the similitude of in appearance or qualities.
I. “-like” is a suffix which means like or characteristic of. Examples of use of the suffix “-like” are dog-like, manlike, homelike, coward-like, doll-like, catlike, jellylike, childlike, and sheeplike.

The following commonplace situations A to D were known prior to 2005. Judicial notice is taken of the situations and the situations are evidence to be utilized in evaluating the invention.
A. If a teenager is asked to do something he does not like doing, such as for instance doing dishes or taking out the trash or picking up his room, the teenager often will indicate his dislike by, without saying anything, (1) rolling his eyes, (2) frowning, (3) shaking his head, and/or (4) motioning his hands or arms in clear disapproval.
B. In a teenager is asked to do something he does no like doing, such as for instance doing dishes or taking out the trash or picking up his room, the teenager often will indicate his dislike by, without speaking any understandable work, indicate his dislike by (1) grunting, (2) moaning, or (3) sighing.
C. When a dog's owner returns home from work and his runs up wagging his tail to be petted, that indicates the dog likes the owner returning home and likes being petted by he owner.
D. When a dog picks up in his mouth a ball with which he has played and runs up to his owners with the ball in his mouth with his tail wagging, drops the ball at the owners' feet, looks up at the owner and barks, that indicates the dogs likes to play with the ball and want to again play with the ball.

It is sometimes thought at first blush that emotions in human beings can only be expressed by speaking, and that emotions can only be detected by listening to the spoken word. This is, on closer look, simply not the case. Emotions can be expressed without speaking. First, as is well known, emotion manifests itself in neuromuscular, respiratory, cardiovascular, hormonal, and other bodily changes. Such changes in many cases are evident in an individual regardless of whether the individual is speaking. Second, words such as countenance and emote have evolved and long existed in the English language that are used to describe how an individual expresses himself without speaking. Third, there are many well known oft repeated instances in common every day life of individuals expressing themselves without speaking. For example, a child who is asked to do something that he does not like to do (such as, for example, “Eat your vegetables!”) in many cases will roll his eyes, sigh, shake his head, or purse his lip to evidence his dislike. These are not spoken expressions, but they still clearly express and communicate the emotions of the child.

Similarly, It is sometimes thought at first blush that emotions in animals can not be detected because animals can not speak. This is, on closer look, simply not the case. Emotions can be expressed without speaking. First, emotion in animals, as is the case in human beings, manifests itself in neuromuscular, respiratory, cardiovascular, hormonal, and other bodily changes. Second, there are many well known oft repeated instances in common every day life of animals expressing themselves without speaking. For example, when a dog's owner returns home after work and the dog is happy to see the owner, the dog's tail is wagging and the dog runs up to the owner to be petted. Or, if a dog wants the owner to throw a ball, the dog will bring the owner the ball. Or, if a dog is afraid of an object, it may put its tails between its legs and move away from the object. Or, if a dog believes its owner is in danger from another person, the dog may bite that person. Such are not spoken expressions, but they still clearly express and communicate emotions of the animal.

Some individuals sincerely believe and insist that animals can not, because they can not speak understandable words, express and communicate emotions or indicate if they like or dislike something. This belief is one factor that makes the invention non-obvious. An important feature of the invention is determining which vibrational sounds and frequencies are acceptable to an animal. Individuals who believe it is not possible to evaluate if an animal likes or dislikes a particular sound or object would never consider trying to evaluate whether an animal dislikes a particular sound or vibration. The individual could also question whether the invention is even possible.

The invention focuses in part on evaluating whether an animal likes or dislikes a particular configuration of the massage glove of the invention. The prior art does not suggest or discuss such a procedure. To practice the invention, it must first be recognized that it is possible to determine whether an animal likes or dislikes something, after which the expressions of the animal around the glove of the invention when it is in a particular configuration must be observed to determine of the animal likes or dislikes a particular configuration of the glove.

Voltaire knew about the emotions of dogs. He used the story of a lost dog to refute a thesis by Descartes that dogs are incapable of any kind of suffering. In his Dictionnaire philosphique Voltaire responded to Descartes:
Judge this dog who has lost his master, who has searched for him with mournful cries in every path, who comes home agitated, restless, who runs up and down the stairs, who goes from room to room, who at last finds his beloved master in his study, and shows him joy by the tenderness of cries, by his leaps, by his caresses. Barbarians seize this dog who so prodigiously surpasses man in friendship. This nail him to a table and dissect him alive to show you the mesenteric veins. You discover in him all the same organs of feeling that you posses. Answer me, mechanist, has nature arranged all the springs of feeling in this animal in order that he should not feel? Does he have nerves to be impassive?

The article “Your Dogs Emotions—Things Every Dog Owner Should Know” (submitted to ezinearticles.com on Jan. 7, 2006), notes:
“Your dog is more similar to you in their emotions than in their mentality. Some of their emotional reactions are so much like ours, that we tend to humanize them. The dogs emotions are visibly expressed in his eyes and face, his ear and tail movements, his posture, and general behavior. Sometimes they are vocally expressed as well. Your dog can feel and express the same emotions as we do: love, hate, joy, sorrow, grief, anxiety, jealously, remorse, anger, fear, and even more subtle ones such as distrust and resignation.”

A question that has been raised is: How can one tell if an animal likes being massaged with the glove of the invention because the animal may simply like being petted (with or without the glove the glove of the invention) or may like being near its owner (with or without the glove). This appears to be a reasonable question. On closer look, however, it is not difficult to determine whether the animal likes being massaged with the glove.

First, an animal evidences its like (or dislike) of something in different ways. An animal may like being petted and sit contentedly on the lap of its owner. However, if the animal really likes being massaged with the glove of the invention—which is often the case—the animal will not simply sit contentedly on the lap of its owner, instead it will roll on its side or back, relax and begin to fall asleep. Accordingly, in many cases, the different way in which the animal responds to the glove of the invention while being petted evidences that the animal likes the glove.

Second, simply focusing on the time period during which the animal is being petted is unnecessarily limiting in evaluating whether the animal likes being massaged with the glove of the invention. The expressions of the animal before or after use of the glove often provide important evidence of whether the animal likes the glove. For example, if a dog sees the glove being held by the owner and puts his tail between his legs and moves away from the owner, that indicates the dog is afraid of and does not like the glove. If, instead, the dog runs up to the owner with tail wagging and nuzzles the glove, that indicates that the dog likes the glove. Or, if the owner stops massaging the dog with the glove, and the dog nuzzles the owner's hand or wrist to ask that the massaging continues, that indicates the dog likes the glove. Or, if the dog picks up the glove with his mouth and brings the glove to the owner, that indicates the dog likes the glove. Consequently, if an individual focuses on the totality of the expressions of an animal, such expression readily evidence emotion and evidence whether the animal likes or dislikes something.

The amplitude of the sound produced by the vibrator(s) is important. A sound that is too loud will frighten or irritate an animal. It is preferred that the amplitude of sound produced by vibrators be less than sixty decibels. As noted above, one way of determining if the amplitude, frequency, and/or composition of a sound produced at or adjacent an animal's body is appealing is whether the sound causes the animal to leave the vicinity of the sound or to try to get away from the sound. If the animal stays in the vicinity of the sound, then that indicates the sound is liked by the animal. If, for example, a cat on hearing the sound begins to purr or to play with or rub against the source of the sound, then the cat likes the sound. Or, if a dog on hearing the sound lays near or against the source of the sound, then the dog likes the sound. The sound produced by the glove apparatus need not be produced by a vibrator 30 to 34. Vibrators 30 to 34 can be provided which produce little, if any, sound. A sound generating module can be mounted on the glove apparatus and can produce sound in combination with or in place of (the vibrator may, practically speaking, be “silent”) sound produced by a vibrator 30 to 34. The sound generating module can produce melodies of songs, singer's voices, orchestral music, or any other desired kind of music or audible sound. An external sound source can also be utilized in combination with the mitt apparatus of the invention. The external source could, for example, comprise a CD player, a radio, an individual or group singing or humming, etc.

If desired, sound produced by the external source can be utilized in combination with sound produced by the sound module. One way this is accomplished is to produce sound with the external source simultaneously with sound produced by the sound module (or vibrator). Another way it is accomplished is to produce sound with the external source before or after sound is produced by the sound module. A further way it is accomplished is to do both, i.e., to produce sound with the external source simultaneously with sound produced by the module and to produce sound at a time or times when sound is not being produced by the sound module.

The sound produced by the sound generating module or vibrator or by the external sound source preferably is appealing or soothing to the animal being massaged and groomed with glove 10.

In addition to the frequency and amplitude of sound that a vibrator produces, the magnitude and frequency of vibrations produced by a vibrator can be selected such that an animal likes the vibrations when the glove of the invention is utilized to groom the animal. While it Is possible to utilize vibrators that produce vibrations having a frequency in the range of 20 to 20,000 Hz and magnitudes (amplitudes) from 0.05 mm (or less) to 3 mm (or more), presently preferred vibrators produce vibrations having a higher frequency of at least 80 to 160 Hz and having smaller magnitudes in the range of 0.5 mm to two mm.

As used herein, the terms “fur” or “fur coat” refer to a coat of hair on an animal. The coat of hair can consist of a single layer of hair that partially or substantially completely covers the animal. The coat of hair can also consist of multiple layers of kinds of hair. For example, a coat of fur can includes a layer of oily guard hair and a layer of thicker under fur beneath eh layer of guard hair. The guard hair functions to she moisture. The underfur functions as an insulating blanket that keeps the animal warm. In some cases, animals have several or many hairs per follicle. Example of animals with fur coat are, without limitation, set forth below in Table I.

TABLE I
Animals with Fur Coats

| Animal | Family | Description of Fur |
|---|---|---|
| Beaver | Rodent | Dark brown; short, thick fur |
| Chihuahua | Dog | Brown; short fur |
| Chinchilla | Rodent | Blue-gray; long, branched, fine fur |
| Coyote | Dog | Gray, yellow-gray, tan; long thick fur |
| Ermine | Weasel | White, black; short, thick fur |
| Fisher | Weasel | Dark brown; short soft fur |
| Fitch | Weasel | Yellow, beige, brown, black; long, silky fur |
| Fox | Dog | Red, blue, silver, white; long, soft fur |
| Greyhound | Dog | White, grey, black, brown; short fur |
| Lynx | Cat | Beige, white; long silky fur |
| Maltese | Dog | White; long fur |
| Marine Coon | Cat | Dark brown; long fur |
| Marten | Weasel | Blue-brown; soft, thick fur |
| Opossum | Opossum | Creamy; short, rough fur |
| Persian Lamb | Sheep | Black, brown, gray; wooly, tightly curled fur |
| Rex | Cat | White gray; sort fur |
| Seal | Seal | Bray, salmon, silver, white; short, silky or |
| | | stiff fur |
| Sphynx | Dog | Short, downy, almost invisible fur. |
| Squirrel | Rodent | Gray; short, soft fur |

A human being is not considered an animal for purposes of the invention. The mitt apparatus of the invention is specifically designed for and intended for animals other than human beings. Although it is believed that the invention likely can be advantageously used with care on all or nearly all animals, the presently anticipated primary use of the invention is in connection with popular domesticated four legged animal that have a fur coat; namely, cots, dogs, and horses.

In a further embodiment of the invention, the grooming glove is provided with vibrators that can be adjusted to alter the frequency and magnitude of vibrations produced by the vibrators and/or to alter the frequency(s) and amplitude(s) of sound produced by the vibrators or by other apparatus used on or in conjunction with the grooming glove.

The presently preferred construction of a vibrator 30 is illustrated in FIG. 4. Vibrator 30 includes a wooden housing 40. Housing 40 includes an arcuate top surface 41, a flat bottom surface 42, and flat end surfaces 43 and 44. A cylindrical aperture 45 is formed in housing 40 and is shaped and dimensioned to receive and house vibrator motor 46. Electrical wiring 48 extends from motor 46, through seal 47, and to battery pack 60. Button or switch 61 is utilized to turn motor 46 on and off (and to turn the motors in vibrators 31 to 34 on and off since battery pack 60 also provides electricity to these vibrators).

Housing 40 can be formed from any desired material, but is presently preferably formed from wood. One reason wood is preferred is that wood muffles, deadens, and transmits sound produced by motor 46 in a way that makes the sound more appealing to an animal, in particular to a dog or cat.

Aperture 45 is sized to be somewhat larger than motor 46 so that motor 46 will have room to vibrate in the event the wood comprising housing 40 expands due to moisture intake or change in temperature. Such expansion o the wood reduces the size of aperture 45.

Seal 47 slides along wiring 48 and, after motor 46 is inserted in aperture 45, is slid along wiring 48 and pressed into aperture 45 to seal motor 46 in aperture 45. Caulk or other sealing means besides or in addition to seal 47 can be utilized to seal motor 46 in aperture 45. However, seal 47 or other sealing means utilized to seal motor 46 in aperture 45 does not prevent motor 46 from producing vibrations when motor 46 is operated with electricity from battery pack 60. Seal 47 functions to prevent moisture from passing through seal 47 to enter aperture 45. Seal 47 sealingly fits into aperture 45. Battery pack 60 can be mounted at any desired location on glove 10, or can be separate from and connected to glove 10 during use of glove 10. In FIG. 1, battery pack 60 is mounted on the cuff of glove 10.

When vibrator 30 is installed in glove 10, arcuate outer surface 41 faces in a direction outwardly away from the inside of glove 10 and, consequently, faces pad 35 and contacts pad 35 or contacts the portion of glove 10 intermediate surface 41 and pad 35. This is an important feature of the invention because when a vibrator 30 and pad 35 are pressed against the body of an animal, surface 41 can, by manipulating the user's finger or fingers in stall 17, be rolled over the body of an animal in one or both of the directions indicated by arrows B in FIG. 4. Such rolling or rocking of housing 40 against the skin of an animal often is enjoyable to the animal and the animal likes such action of surface 41. While the entire surface 41 is arcuate in the embodiment of the invention illustrated in FIG. 4, surface 41 is preferably includes at least a portion which is arcuate and facilitates the rolling of surface 41 in at least one of the directions indicated by arrows B in FIG. 4. Further, even if surface 41 is simply gently pressed against the fur and skin of an animal and is not rolled over or rocked on the animal's body, the curvature of surface 41 is similar to the curvature of a pad on the paw of an animal so that glove 10 more closely replicates what an animal feels when the paw of another animal is pressed against the animal.

Pads 35 to 39 are silk screened onto the palm of glove 10 or are otherwise formed on glove 10 such that pads 35 to 39 are, along with glove 10, pliable so that pads 35 and 39 and the portion (if any) of glove 10 intermediate a pad 35 to 39 and a vibrator 30 to 34 pliably conforms to surface 41 when a pad 35 to 39 and a vibrator 30 to 34 are pressed in a direction against the skin of an animal. While the outer surface of each pad 35 to 39 can be smooth, it is preferred that the surface of each pad 35, 39 be textured to simulate the surface of a paw pad on a living animal. While some smaller animals may have paw pads with a smooth outer surface, the pads on larger cats or dog typically have a somewhat rough texture, or can take on a rough texture when the animal is walking or running and the paw pronates or supinates and causes a paw pad to extend or compress.

Having described my invention in such terms as to enable those of skill in the art to make and practice it, and having described the presently preferred embodiments thereof, I claim:

1. A method to massage and groom a four-legged animal having a fur coat, comprising the steps of
(a) providing a pliable paw-shaped glove having
(i) a palm,
(ii) pliable pads on said palm,
(iii) finger stalls inside said glove, and
(iv) imitation fur on said palm;
(b) selecting a first sound having a selected frequency(s) and amplitude(s);
(c) selecting a first vibrator which
(i) produces
vibrations having a selected frequency and magnitude of vibration, and
said first sound having said selected frequency and amplitude, and,
(ii) includes an arcuate outer surface;
(d) mounting said vibrator on said palm of said glove beneath one of said pads such that said arcuate outer surface faces said one of said pads;
(e) operating said vibrator to produce said vibrations and said sound;
(f) massaging and grooming the four-legged animal with said glove while rolling said one of said pads and said arcuate surface of said vibrator over the animal.

2. The method of claim 1 wherein said vibrator
(a) includes
(i) a wood housing;
(ii) an opening extending into said housing; and,
(iii) a vibrator motor mounted in said opening in said housing; and,
(b) produces sound having an amplitude of less than sixty decibels.

3. The method of claim 1 including
(a) determining if the four-legged animal likes being groomed with said glove;
(b) if the four-legged animal does not like being massaged and groomed with said glove, the additional steps after step (g) of
(i) selecting a second vibrator to replace said first vibrator selected in step (b), said second vibrator having at least one property different from said first vibrator, said property being selected from a group consisting of a sound different from said first sound produced by said first vibrator, a frequency of vibration different from the frequency of vibration produced by said first vibrator, and a magnitude of vibration different from the magnitude of vibration produced by said first vibrator;
(ii) mounting said second vibrator on said glove in step (d) instead of said first vibrator; and
(iii) repeating steps (e), (f), (g).

4. The method of claim 1 including
(a) determining if the four-legged animal likes being groomed with said glove;
(b) if the four-legged animal does not like being massaged and groomed with said glove, the additional steps after step (g) of
(i) adjusting said first vibrator to change at least one property selected from a group consisting of a sound different from said first sound produced by said first vibrator, a frequency of vibration different from the frequency of vibration produced by said first vibrator, and a magnitude of vibration different from the magnitude of vibration produced by said first vibrator; and,
(ii) repeating steps (e), (f), (g).
